(19) United States
(12) Patent Application Publication
(10) Pub. No.: US 2025/0302267 A1
(43) Pub. Date: Oct. 2, 2025

(54) CHARGING AND REFUELLING STATION FOR AUTONOMOUS CLEANING ROBOTS

(71) Applicant: LIONSBOT INTERNATIONAL PTE LTD.,, Singapore (SG)

(72) Inventors: Kamalesh Boopathi, Singapore (SG); Tushar MOHAN, Singapore (SG); Mohan Rajesh ELARA, Singapore (SG); Terntzer Dylan NG, Singapore (SG)

(21) Appl. No.: 18/863,368

(22) PCT Filed: May 4, 2023
(86) PCT No.: PCT/SG2023/050301

§ 371 Date: Nov. 6, 2024

(30) Foreign Application Priority Data
May 6, 2022 (SG) 10202204792R

(51) Int. Cl. A47L 11/40; G01F 23/30; G01S 17/931; G01W 1/14

(52) U.S. Cl. CPC A47L 11/4091; A47L 11/4011; G01F 23/30; G01S 17/931; G01W 1/14; A47L 2201/022; A47L 2201/024; A47L 2201/026

(57) ABSTRACT

A charging and refuelling station for an autonomous cleaning robot including; a charging mechanism including a sprung mount resiliently supported on the charging and refuelling station, a swivel mount pivotally supported on the sprung mount, the swivel mount supporting contact plates for contacting charging contact plates of the autonomous cleaning robot when docked at the station; and a water exchange system including a tap for fresh water refilling of the autonomous cleaning robot, and a draining system including a drain tank for receiving water draining from the autonomous cleaning robot.

### CROSS-REFERENCE TO RELATED APPLICATION

This application is a national stage application, filed under 35 U.S.C. § 371, of International Patent Application No. PCT/SG2023/050301, filed on May 4, 2023, which claims priority to Singapore Patent Application No. 10202204792R filed with the Intellectual Property Office of Singapore on May 6, 2022, both of which are incorporated by reference herein in their entirety.

### FIELD

The present invention generally relates to robotic systems, and in particular to a charging and refuelling station for autonomous cleaning robots.

### BACKGROUND

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Autonomous cleaning robots used in industrial and commercial applications generally require regular human intervention to recharge, rewater and remove dirty ‘black’ water from the cleaning robot. However, the operator of the cleaning robot may not always be available to conduct these interventions. Also, this can limit the length of time where the cleaning robot can operate independently.

It would therefore be advantageous to be able to minimise such human intervention to allow the cleaning robot to operate over long work cycles, with the operator only being required to intervene, for example when maintenance is required for the robot.

### SUMMARY

According to an aspect of the present disclosure, there is provided a
charging and refuelling station for an autonomous cleaning robot including;
a charging mechanism including a sprung mount resiliently supported on the charging and refuelling station, a swivel mount pivotally supported on the sprung mount, the swivel mount supporting contact plates for contacting charging contact plates of the autonomous cleaning robot when docked at the station; and
a water exchange system including a tap for fresh water refilling of the autonomous cleaning robot, and a draining system including a drain tank for receiving water draining from the autonomous cleaning robot.

In some embodiments, the sprung mount is resiliently mounted to a structural chassis of the charging and refuelling station via a spring assembly to allow for movement of the sprung mount towards and away from the chassis when force is applied by the cleaning robot on the swivel mount.

In some embodiments, the spring assembly comprises at least one compression spring supported on a linear shaft extending from the structural chassis.

In some embodiments the sprung mount is further supported by at least one linear bush and stopper washer.

In some embodiments, the charging and refuelling station further comprises at least one linear rail and carriage for reducing flexure and play of the charging mechanism during movement thereof.

In some embodiments, the water exchange system further comprises a flow sensor for detecting water flow to the autonomous cleaning robot, and any surge in the water flow thereto.

In some embodiments, water is drained by gravity from the drain tank.

In some embodiments, the draining system further comprises at least one float sensor for sensing water level within the drain tank.

In some embodiments, said float sensors are located at different depths within the drain tank, to thereby control an opening and closing of a valve controlling draining of the water from the autonomous cleaning robot.

In some embodiments, the drain tank further comprises a rinsing system including at least one rinsing nozzle for rinsing the drain tank.

In some embodiments, the rinsing system comprising two of the rinsing nozzles including a 3-way flushing nozzle and a fan nozzle, and a dual outlet solenoid valve for controlling water flow to each of the rinsing nozzles.

In some embodiments, the charging and refuelling station further comprises at least one rain sensor provided on the station for sensing external water or water leaks within the station.

In some embodiments, the charging and refuelling station further comprises a plurality of the rain sensors, each said rain sensor being located at a different position within the charging and refuelling station.

In some embodiments, the charging and refuelling station further comprises a LIDAR reflective profile provided on the charging and refuelling station for guiding a LIDAR system of the autonomous cleaning robot.

In some embodiments, the LIDAR reflective profile is a V shaped profile.

Other aspects and features will become apparent to those of ordinary skill in the art upon review of the following description of specific embodiments in conjunction with the accompanying figures.

### BRIEF DESCRIPTION OF THE DRAWINGS

In the figures, which illustrate, by way of example only, embodiments of the present invention,

FIG. 1 is a front perspective view of a charging and refuelling station according to the present disclosure;

FIG. 2 is a front perspective view of the charging and refuelling station of FIG. 1 with the enclosure removed;

FIG. 3 shows reflective shaped profiles used by the charging and refuelling station for the LIDAR system of the cleaning robot according to the present disclosure;

FIG. 4 shows the field of vision of the LIDAR system in the cleaning robot;

FIG. 5 is a detailed perspective view of the charging mechanism of the charging and refuelling station according to the present disclosure;

FIG. 6 is an exploded perspective view of the charging mechanism of FIG. 5;

FIG. 7 is a detailed view of the robot contacts of the charging mechanism of FIGS. 5 and 6 when in contact with the charging contacts of the cleaning robot;

FIG. 8 is a detailed view of the water supply and rinsing system of the charging and refuelling station according to the present disclosure;

FIG. 9 is a detailed view of the rain sensors of the charging and refuelling station according to the present disclosure; and

FIGS. 10 and 11 respectively show a perspective and cross-sectional view of the rinsing system of the charging and refuelling station according to the present disclosure.

Other arrangements of the invention are possible and, consequently, the accompanying drawings are not to be understood as superseding the generality of the preceding description of the invention.

### DETAILED DESCRIPTION

Throughout this document, unless otherwise indicated to the contrary, the terms “comprising”, “consisting of”, “having” and the like, are to be construed as non-exhaustive, or in other words, as meaning “including, but not limited to”.

Furthermore, throughout the specification, unless the context requires otherwise, the word “include” or variations such as “includes” or “including” will be understood to imply the inclusion of a stated integer or group of integers but not the exclusion of any other integer or group of integers.

Example embodiments of the present invention will now be described with reference to the accompanying drawings. The terminology used herein is for the purpose of describing particular embodiments only and is not intended to limit the scope of the present invention. Other definitions for selected terms used herein may be found within the detailed description of the invention and apply throughout the description. Additionally, unless defined otherwise, all technical and scientific terms used herein have the same meanings as commonly understood by one or ordinary skill in the art to which this invention belongs. Where possible, the same reference numerals are used throughout the figures for clarity and consistency.

The charging and refueling station (100) for an autonomous cleaning robot (202) according to the present disclosure is intended to be a solution for reducing human intervention for long work cycles as well as to preferably provide features which allow for human intervention if necessary, especially to provide an alarm to the user on a possible error with the charging and refueling station (100) and to case the maintenance thereof. Firstly, the charging and refueling station (100) preferably uses a simple fool proof method to make the LIDAR in the cleaning robot (202) detect and plan a docking path to the charging and refueling station (100). Then the cleaning robot (202) can be aimed to mate with a charging mechanism (4) of the charging and refueling system (100) by overcoming the unavoidable errors due to both physical hardware uncertainties and computational limitations, particularly maintaining proper copper surface area contact between the charging mechanism (4) and the charging contacts (203, 204) of the cleaning robot (202).

The charging and refueling station (100) for an autonomous cleaning robot according to the present disclosure can also preferably automate the water transfer process using a simple and intelligent mechatronic system design that may include a flow sensor (28) monitoring the surge of water flow rate, at least one float level sensor (39,40) to check as the draining system (60) drains waste water from the cleaning robot (202) by gravity without any pump, and preferably two kind of nozzles (41,42) for rinsing the waste water drain tub (6) in a sequential manner without pressure loss to cover most of the area and at least one rain sensor (33,34,35,36,37) for detecting internal leaks within the charging and refuelling station (100) as well as water incoming from the exterior of the station (100).

The charging and refuelling station (100) according to the present disclosure may in particular preferably include one or more of the following features:
a) a cantilevered compact charging mechanism (4) with a swivelling mount (14) that houses copper contact plates (12,13) and temperature sensors/thermistors (20) that helps to ensure full normal surface area contact without any gap between the charging mechanism contacts (12,13) and the charging contacts (203, 204) of the cleaning robot (202), even when the cleaning robot is docked slightly non-perpendicular to the charging and refuelling system (100);
b) a charging mechanism (4) that preferably has a long travel and return back motion supported by spring action, and is preferably largely made from made of plastics so as to be light in weight. The swivelling enclosure (15) for the charging mechanism (4) covering the wires may also act as a load transferring medium;
c) a reflective, preferably V shaped Profile provided on the charging and refuelling system (100) which assists the LIDAR system of the cleaning robot (202) to differentiate among the other objects in the environment and to navigate the robot towards the centre of the V shaped profile;
d) a fully autonomous water exchange system (50), preferably with a tap (5) in the system for supplying fresh water to the cleaning robot (202), and with a flow sensor (28) monitoring the flow, and a draining system (60) including a drain tray (6) in the system can collect the black water from the cleaning robot with float sensors (39,40) checking for chokes, the drain tray (6) draining by gravity without a pump; and
e) an internal rinsing system in the draining system (60) when there is a huge load of black water transfer happening to ensure that any chunky debris is flushed and that there is also no sedimentation within the drain tank (6).

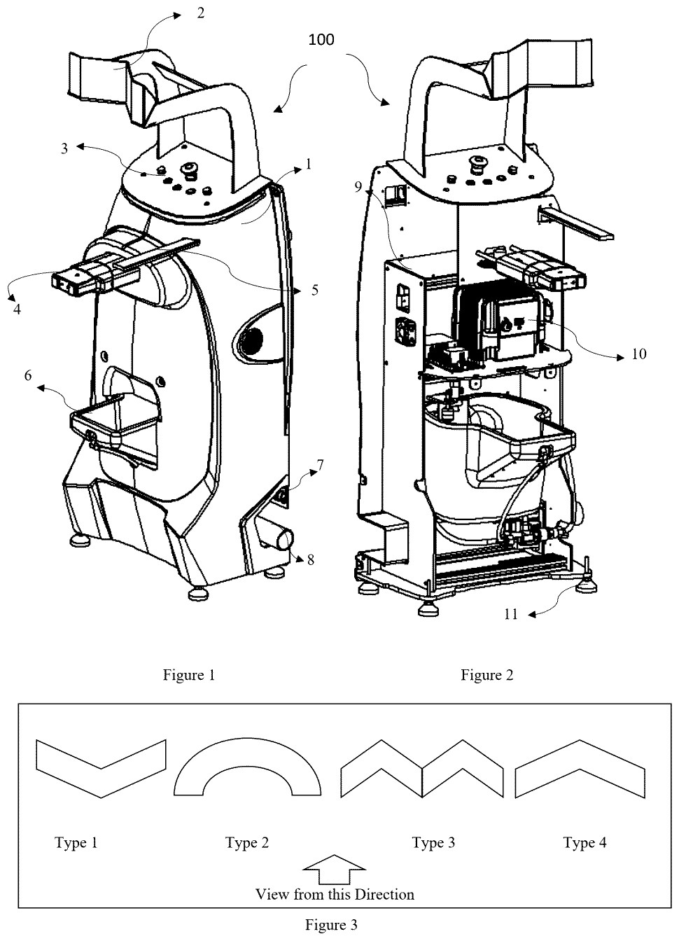

FIG. 1 shows the charging and refuelling station (100) with an enclosure (1) covering the internal components of the station (100). FIG. 2 shows the naked station (100) without the enclosure (1) exposing the structural chassis (9) resting on four adjustable leveling feet (11). The major functional features of the described embodiment of the charging and refuelling station (100) are associated with the reflective V profile (2) for the LIDAR system, the charging contact mechanism (4), and the fresh water tap (5) with its hydraulic line and waste water drain tub (6) with rinsing system. An additional safety feature which enhances the justification of invention is implementing rain sensors (33, 34, 35, and 36) in multiple potential leak spots, thus casing the user inspection during maintenance of the station (100).

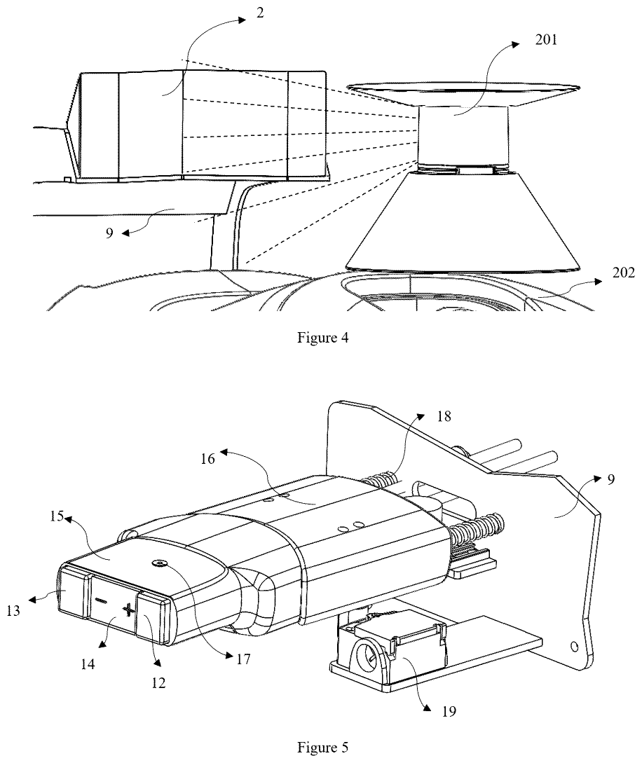

The reflective V Shaped profile (2) is fixed on the structural chassis (9) at particular height where the reflective profile (2) can cover the good range of field of vision of the LIDAR system (201) in the Robot (202) as shown as in FIG. 4 with LIDAR's Cone shaped field of vision.

The reflective shaped profile (2) is detected by the LIDAR system (201) due to the difference in the reflected intensity and thus no other different object in the environment gets detected. Thus, it can be of any shape as shown in FIG. 3, for example an inverted V, Inverted U, W, and V shape, as desired to enable easy detection of the central plane of the station (100) by the LIDAR system (201). The converging V profile has given good result so far and it is implemented in a particular embodiment of the charging and refuelling station (100) described herein.

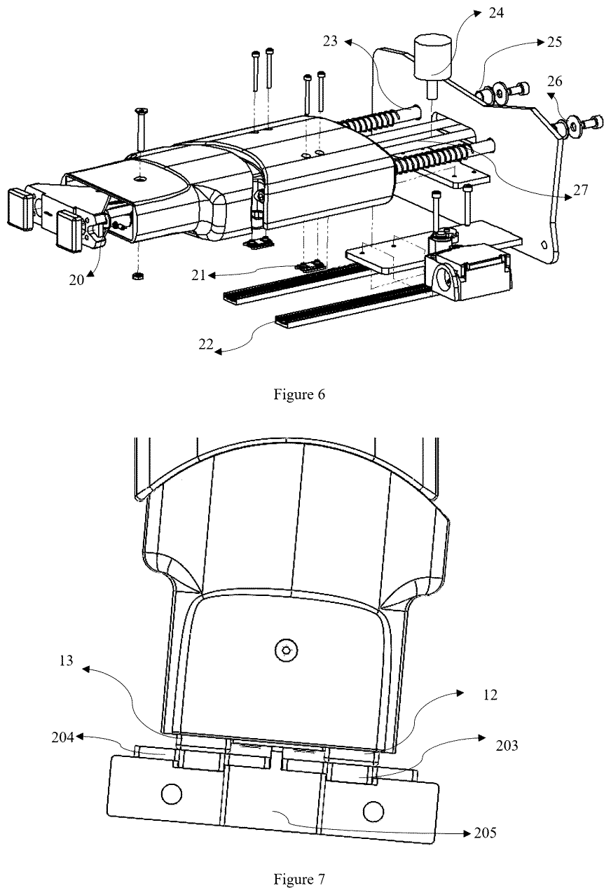

The charging mechanism (4) which is connected to a charger in the system, should have a desired operating temperature when delivering the necessary current via positive (12) and negative (13) copper plates to the cleaning robot charging contact plates (203,204). FIG. 5 shows the charging mechanism (4) and FIG. 6 is an exploded view of the same showing some of the components which are housed inside and underneath the plastic enclosures of the mounts (14, 15, 16).

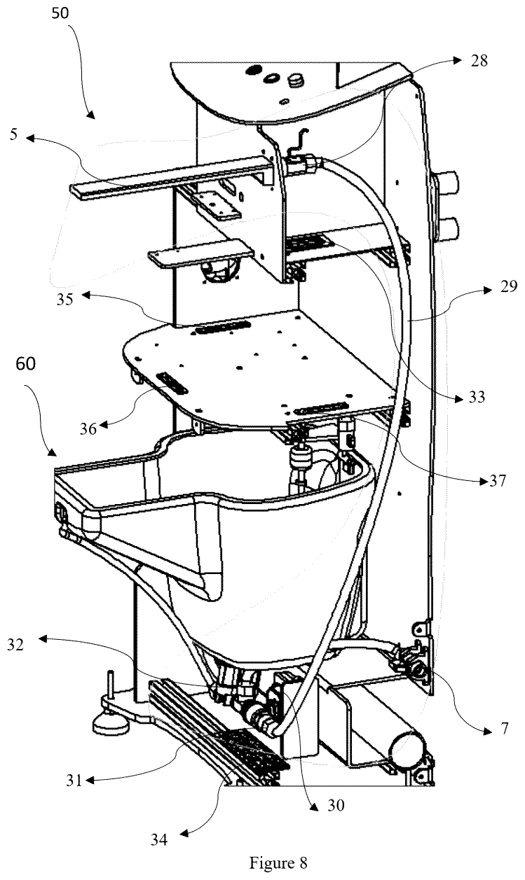

The swiveling mount (14) supports two copper contact plates (12,13) with each of them connected to a wire (27) and a thermistor (20). The swivel mount (14) is supported within an enclosure (15) which also swivels together with the mount (14) and covers the wires (27) to the copper contact plates (12,13). The enclosure (15) together with the supported swivel mount (14) are pivotally connected to a sprung mount (16) with a single bolt (17). The sprung mount (16) resiliently supports the swivel mount (14). The enclosure (15) has a curved rear end that is cut concentric to the pivot and that has an edge intended to be in contact with a cooperating curved surface of the sprung mount (16). This allows any load on the swiveling mount (14) to be transferred to the sprung mount (16) along with the load going to the bolt (17) during the impact with the cleaning robot charging contacts as shown in FIG. 7. The sprung mount (16) provides a swivel angle limit to the swivel mount (14) thereby allowing the swivel mount (14) and enclosure (15) to play within a certain movement limit that allows for alignment of the swivel mount (14) normal to the direction of the impact of the copper contact plates (203,204) from the robot (205). The width and swivel angle limit ensures that the copper contact plates of the robot side (203 and 204) and station side (12 and 13) are mated with proper contact even in situations where there is a degree of alignment error between the station (100) and the robot (202).

The sprung mount (16) is sprung against the station chassis (9) with two long compression springs (18) respectively coiled over two linear shafts (23), and with linear bushings (25) and stopper washers (26), aiding long travel of the charging mechanism (4). Since the weight of the sprung mass of the charging mechanism (4) may be lower with the compact plastic mounts (15,16), the passive retraction may be smooth. Additional linear rails (22) and carriages (21) may also be incorporated to reduce the flexure and play of the mechanism (4) during long travel compression. During this long travel, a limit switch (19) can be engaged most of the time even when the robot (202) stops at varying stopping distances in a large number of cycles of docking sequences with the station (100). There may be an internal safety rubber bumper stopper (24) on the station (100) to physically reduce the impact when the robot (202) does not stop due to reasons like signal failure.

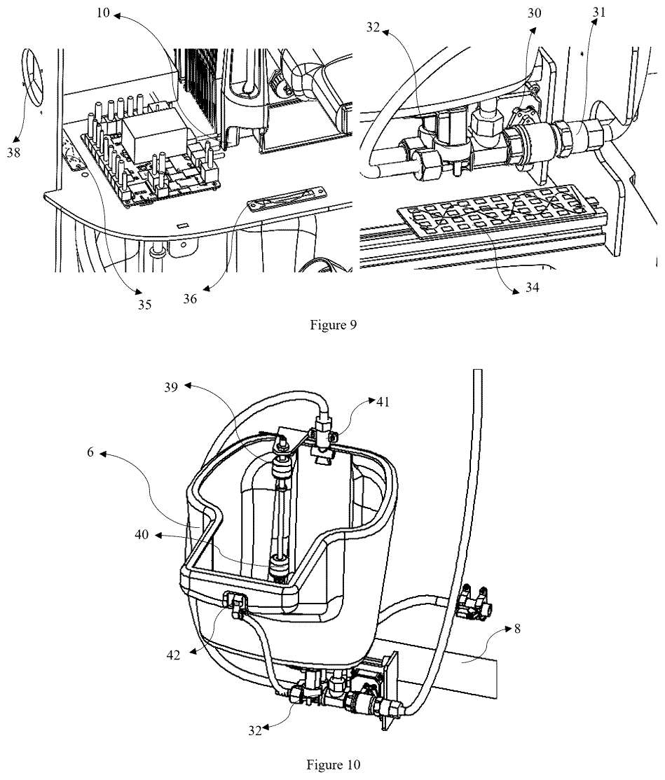

The fresh water supply system as shown in FIG. 8 includes a tap (5) for supplying clean water to the cleaning robot (202) when docked to the station (100), and a flow sensor (28) for determining the presence of a water flow or any surge in the water flow rate. The water enters the station (100) through a water inlet (7) having a choke valve, and the water gets spitted to two directions, one going to the tap (5) to fill the robot (202) with fresh water and the other going to rinse the black water drain tray (6). The passage of water to the tap (5) is controlled with help of a servo motorized-ball valve (30) and a passive flow reducer (31) is fitted to restrict the tap flow rate even when the station inlet flow rate is up to five times higher than the tap flow rate. The tap (5) is designed to provide a desired water flow to the robot water tray without spilling and also preferably has a feature that prevents dripping of water from the tap (5) after the robot (202) undocks from the station.

The water lines are mostly steel braided hoses (29) which have a low possibility of shear or puncture thereby causing leaks. Thus, the major possibility of potential leaks is in the connection points of fittings, valves and hoses. Water leaks are huge concern for the station (100) which has many electronic and power components (10). There is also a possibility of water from environment coming into the station (100), for example potentially through the cooling fan vent hole (38). Thus, in order to detect any internal leaks or incoming water from exterior of the station and to shut down the station (100) autonomously, rain sensors (33, 34, 35,36, 37) can be put in different spots on the station (100) as shown in FIG. 8 and FIG. 9. The rain sensors (33, 34, 35,36, 37) are printed circuit boards connected in series, and having different patterns on them. Thus, each one of the rain sensors (33, 34, 35,36, 37) gives different outputs due to a change in resistance within the sensor. This helps to minimize the wiring as well as to help to identify the exact leak or water spill off spots during the maintenance.

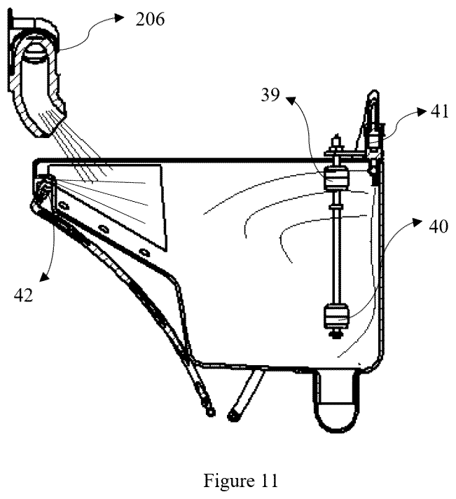

The draining system (60) has a big drain tub (6) which catches the black water from the robot outlet valve (206) as shown in the FIG. 11. The tub (6) has to be big enough to collect the waste water, for example of around 120 liters of volume, and to drain to the outlet (8) by gravity instead of using a pump. This is strictly needed as a safety check to ensure that there is always draining happening when the robot outlet valve (206) is opened. As seen in FIG. 10, there are two float sensors (39,40) incorporated at different depths within the tub (6), the deepest one (40) checking the presence of water before initializing the draining from the robot and the top most one (39) checking the rise of water during the draining from the robot. These checks control the opening or closing of the robot side valve (206).

This huge transfer of black water from the industrial floor cleaning robot (202) can leave some chunky debris within the drain tub (6) that can result in a thick sedimentation accumulating over the time within the tub (6). This reduces the efficiency of draining and eventually cause breakdown of the cleaning robot (202) without proper governance by humans. This problem can be resolved by having a rinsing system as shown in FIGS. 10 and 11. The water coming into the station (100) is split and goes to solenoid valves (32) without any flow reducer. As the area of tub to rinse is huge, using two rinsing nozzles (41,42) may efficiently clean the tub (6) However, supplying water altogether simultaneously with a single solenoid valve can result in a pressure loss. The solenoid valve (32) that may be used here has a dual outlet connecting a 3-way flushing nozzle (41) and a fan spraying nozzle (42) and is opened sequentially, the first sequence lets the water flush from the 3-way nozzle (41) that rinses the two side walls and bottom of the smooth curvy drain tub (6) as seen in the FIG. 11 with stream lines shown. Then, the next sequence lets the water spray from a fan nozzle (42) which covers the area that the other nozzle (41) cannot not rinse.

The charging and refuel system according to the present disclosure may have the following advantages:
a) reduction in the excessive reliability on software and computation performance. Thus, even with certain alignment errors, the charging can be efficient without losing the contact area.
b) the long travel passive spring return charging mechanism with roller-arm type limit switch does not get affected by inaccuracy of stopping point of the cleaning robot due to inertia or computation latency.
c) the reflective V profile is the simplest method to foolproof the cleaning robot navigation and the profile can be optimized to different shapes or dimensions easily after rapid testing.
d) the water transfer between the invention and the cleaning robot is simple and the mechanical parts are not in interference unlike in hydraulic coupling.
e) having a rinsing system in the autonomous station avoids frequent user intervention and also prevents the breakdown of the station as chunky debris will not be accumulated.

It should be appreciated by the person skilled in the art that the above invention is not limited to the embodiment described. It is to be appreciated that modifications and improvements may be made without departing from the scope of the present invention.

It should be further appreciated by the person skilled in the art that one or more of the above modifications or improvements, not being mutually exclusive, may be further combined to form yet further embodiments of the present invention.

What is claimed is:

1. A charging and refuelling station for an autonomous cleaning robot, the charging and refuelling station comprising:
a LIDAR reflective profile provided on the charging and refuelling station for guiding a LIDAR system of the autonomous cleaning robot;
a charging mechanism including a sprung mount resiliently supported on the charging and refuelling station, a swivel mount pivotally supported on the sprung mount, the swivel mount supporting contact plates for contacting charging contact plates of the autonomous cleaning robot when docked at the station;
a water exchange system including a tap for fresh water refilling of the autonomous cleaning robot, and a flow sensor for detecting water flow to the autonomous cleaning robot and any surge in the water flow thereto; and
a draining system including a drain tank for receiving water draining from the autonomous cleaning robot, at least one float sensor for sensing water level within the drain tank, and a rinsing system including at least one rinsing nozzle for rinsing the drain tank.

2. The charging and refuelling station of claim 1, wherein the sprung mount is resiliently mounted to a structural chassis of the charging and refuelling station via a spring assembly to allow for movement of the sprung mount towards and away from the chassis when force is applied by the cleaning robot on the swivel mount.

3. The charging and refuelling station of claim 2, wherein the spring assembly comprises at least one compression spring supported on a linear shaft extending from the structural chassis.

4. The charging and refuelling station of claim 3, wherein the sprung mount is further supported by at least one linear bush and stopper washer.

5. The charging and refuelling station of claim 1, further comprising at least one linear rail and carriage for reducing flexure and play of the charging mechanism during movement thereof.

6. (canceled)

7. The charging and refuelling station of claim 1, wherein water is drained by gravity from the drain tank.

8. (canceled)

9. The charging and refuelling station of claim 1, wherein said float sensors are located at different depths within the drain tank, to thereby control an opening and closing of a valve controlling draining of the water from the autonomous cleaning robot.

10. (canceled)

11. The charging and refuelling station of claim 1, the rinsing system comprising two of the rinsing nozzles including a 3-way flushing nozzle and a fan nozzle, and a dual outlet solenoid valve for controlling water flow to each of the rinsing nozzles.

12. The charging and refuelling station of claim 1, further comprising at least one rain sensor provided on the station for sensing external water or water leaks within the station.

13. The charging and refuelling station of claim 12, comprising a plurality of the rain sensors, each said rain sensor being located at a different position within the charging and refuelling station.

14. (canceled)

15. The charging and refuelling station of claim 1, wherein the LIDAR reflective profile is a V shaped profile.
